(19) United States
(12) Patent Application Publication
(10) Pub. No.: US 2006/0055126 A1
(43) Pub. Date: Mar. 16, 2006

(54) Three-jaw tightening chuck

(76) Inventor: Valentin Rashev Nachev, Sofia (BG)

Correspondence Address: Richard L Byrne;700 Koppers Building, 436 Seventh Avenue, Pittsburgh, PA, 15219-1818, US

(21) Appl. No.: 10/512,169

(22) PCT Filed: Jun. 26, 2002
(86) PCT No.: PCT/BG02/00013

§ 371 Date: Oct. 21, 2004

(51) Int. Cl. B23B 31/12

(52) U.S. Cl. 279/60

(57) ABSTRACT

The present invention relates to a three-jaw tightening chuck, that can be used in machines operating with rotating tools, such as drills, multiflute drills, counter drills, reamers, as well as in NC machines, processing centres, hand held drilling machines, etc. A high accuracy of rotation of the tightened tool is achieved by the invention, as well as an increased force for its tightening. The chuck is working in self-tightening mode during operation, in this way, when using it, the safety, reliability and security is increased. The chuck comprises a main location part, on which a body and a sleeve, immovably connected, are radially and axially beared. In the body, three inclined openings are formed, in which cylindrical gripping jaws are arranged, movably connected through operating teeth with a driving screw, representing a part of a driving mechanism, formed with a cylindrical threaded joint. The construction allows the building in a mechanism for ensuring a definite tightening force and limited overtightening.

### TECHNICAL FIELD

The present invention relates to a three-jaw tightening chuck, that can be used in machines operating with rotating and cutting tools, such as drills, multiflute drills, counter drills, reamers, as well as hand held drilling machines or NC machines.

### PREVIOUS STATE OF THE ART

A three-jaw tightening chuck for securing rotating cutting tools is known, the chuck comprising a body with a main hole for coupling to the rotating driving machine. Three cylindrical openings are formed in the body, the axis of which are inclined towards the axis of the body. Gripping jaws are accomodated in the cited openings, on the surfaces of the jaws being formed teeth, engaged with the conical thread of a gear wheel-nut, the described joint representing substantially driving tightening mechanism. The tightening and the releasing of the tool is carried out by rotating the gear wheel-nut either manually or by the key.

Due to engagement between the inner conical thread of the nut and tooth sectors of the gripping jaws, a logitudinal displacement of the latter is ensured in their openings towards the tail of the tightened tool. On the opposite, in relation to the tooth sectors, side of the gripping jaws, contact surfaces are formed, by which the secured tool is tightened. The contact surfaces are formed as a part of an inner cylindrical surface, an axis of which coinsides with the axis of the body of the chuck.

The basic principle disadvantade of the described construction is the use of a conical threaded joint for driving the gripping jaws. The conical treaded joint, that has equal geometrical characteristic and parameters as the screw surfaces of the nut and the screw, theoretical and in its practical implementation is desighned for immovable joining of two elements. Its application as threaded joint for driving and movement is possible, as by the prototype, if only the screw, i.e. the teeth of the rack of the gripping jaws have different geometrical characteristics and parameters than those of the screw surface of the inner conical thread of the nut Such a compromise treaded joint is defining and connected with a number of disadvantages as irregular location of the contact spots on the teeth of the gripping jaws towards their common midnormal, irregular movement of the gripping jaws, fast wearing of the elements in contact areas, resulting in losing the initial accuracy, as well as low accuracy of rotation of the tightened tool. Another disadvantage of the described construction is unsuitably defined form of the surfaces for contact of the gripping jaws with the tool to be tightened. Their rotation towards the longitudinal axis is accompanied with worsening the accuracy of the tightened tool.

The known construction of a three-jaw tightening chuck operates by tightening the operating tool in the conditions of relatively great loss of tightening force, owing to the big frictional moment, arising in the conical threaded joint as a result of relatively big radius of the conical threaded joint towards the outer diameter of the chuck.

The production of the nut with inner conical tread is connected with high manufacturing costs, proceeded from the necessity for using alloyed steel, heat treatment and obligatory expensive special technologies. As considerable can be defined also the manufacturing costs for preparing the surface and cutting the teeth of the gripping jaws, that is performed with specialized equipment.

A wedge-tightening chuck is known, construction of which includes gripping jaws, formed as flat wedges, which are connected by T-shaped channels with the face of a driving screw and with specially formed separator, in channels of which the tightening wedges are moving. The separator is secured against overturning by a blocking element, for example pin, in relation to two sleeves with immovable joint between them; the sleeves ensure driving the tightening wedges by their rotation around the axis of the main body, on which they are beared and which has a joining surface for the operating machine.

The described wedge-tightening chuck is a construction completed from details of complex form, with high requirements in relation to the accuracy, that defines the use of expensive and complex technological processes and machining. Bearing in mind the above mentioned disadvantages and the high manufacturing costs, the described construction has the smallest percentage from the production of gripping jaws.

A chuck for tightening rotating cutting tools is also known—EP 1040888A1, the chuck comprises two-parts corpus with a form and dimentions of an electric drill, in the horizontal part of the corpus a body is radially and axially beared with three inclined openings, with cylindrical gripping jaws, placed in the openings. The gripping jaws are movably connected through three radial channels with a pulley, immovably connected with a sleeve, in which two cylindrical journals are diametrically situated, the jornals being connected with a bearing system, placed in the vertical part of the corpus. By means of the mentioned bearing system, the sleeve with both cylindrical journals and the pulley, the gripping jaws are moving in direction for tightening or releasing the operating tool.

The transmition of rotational movement to the tightened cutting tool is fulfilled through the joining the body of the chuck to electrical drilling machine, specially created for this aim.

The described construction has limited application, because it has some definite technical disadvantages. The radial and axial bearing the body with the three gripping jaws directly on carrying corpus defines low revolutions of rotation, as well as low values of operated loading and forces, respectively fast wearing the contact surfaces and fast losing the efficiency. The known technical decision, containing bearing system, can not be used in universal cutting machines, such as lathes, milling and drilling machines, processing centres, NC machines, etc. The described known technical decision can not be joined, respectively used in the remain standard electrical drilling machines.

### SUMMARY OF THE INVENTION

In view of the above cited known previous state of the art in the examined field, the object of the present invention is to provide an improved construction of a three-jaw tightening chuck, that is distinguished by simplified and technological construction, ensuring high accuracy for tightening, safety during operation and low manufacturing costs.

A further additional object of the invention is to create possibility for ensuring a definite tightening force and limited overtightening.

The object of the invention is decided by a three-jaw tightening chuck, comprising a body with three openings, the axis of which are inclined towards his axis, the openings being arranged at 1200 one to the other and in which cylindrical gripping jaws are accomodated, connected with a driving mechanism and there is a mechanism with a main hole in the body for attachment to the driving machine.

According to the invention the driving mechanism is located coaxially in the body and is constituted with a cylindrical threated joint and a driving screw, chaped in his part, connected with the gripping jaws as a cylindrical body with three longitudinal guiding strips, orientated at 60° towards three operating teeth, which angled orientation coincides with those of the three inclined openings, to which medial releasing elements are also connected, when the operating teeth are movably united with the gripping jaws by a channel with bigger size of a two-staged channel, formed in each gripping jaw, as the faces of the operating teeth are beveled and in contact with a semicylindrical surface of the two-staged channel and the medial releasing elements are in contact with two transverce semicylindrical strips of the transitional zone of the two-staged channels, when the body is immovably connected with a sleeve and is beared radially and axially with an axled bearing on the main location part and the driving screw is connected with the gripping jaws and is fixed to the body by means of a blocking pin.

According to one variant embodiment of the chuck, according to the invention, the medial releasing elements are formed as screws with cylindrical heads and are connected by means of dismountable joint with the operating teeth of the driving screw.

According to one variant embodiment of the chuck, according to the invention, the medial releasing elements are formed as conical pins with threaded hols and are connected with the operating teeth of the driving screw.

The contact surfaces of the two-staged channels, formed in the gripping jaws are shaped as parts of cylindrical surfaces of a key channel.

According to one variant embodiment, the contact surfaces of the two-staged channels, formed in the gripping jaws are shaped as parts of planes.

According to another variant embodiment, the contact surfaces of the two-staged channels, formed in the gripping jaws, are shaped inclined at acute angle towards the surfaces for tightening the operating tool.

The contact surfaces of the two-staged channels, formed in the gripping jaws, can be shaped at right angle 90° towards the surfaces for tightening the operating tool.

According to one variant embodiment, the surfaces for tightening the operating tool of the gripping jaws are formed as parts of projecting planes.

According to one variant embodiment, the surfaces for tightening the operating tool of the gripping jaws are formed as parts of an inner cylindrical surface.

According to another variant embodiment, the surfaces for tightening the operating tool of the gripping jaws are formed as parts of planes.

The contact surfaces of the operating teeth of the driving screw are formed at an angle towards its longitudinal axis, which corresponds to the angle of inclination of the contact surfaces of the two-staged channels of the gripping jaws, with which they are in contact.

The joining side of the main location part is formed as an extention with a thread and connected to him a nut, fixed with a screw.

The joining side of the main location part is formed as an extention in form of a standard cone 7:24.

The construction of the described three-jaw tightening chuck allows the building in a mechanism for ensuring a definite tightening force and limited overtightening. This mechanism includes a cylindrical belt and a gear ring, formed on the outer cylindrical surface of a flange of the main location part, as the stoping faces of the teeth of the gear ring are radially arranged and their back part is formed near the stoping face of the following tooth like an inclined plane, a catch, arranged in a radial hole, formed in the sleeve, connected immovably with the body of the chuck, when its fixing part is defined by the form and dimentions of one tooth from the gear ring, with which it is engaged, as his stoping face is arranged against the stoping faces of the teeth, the catch is connected by means of a transverse opening with a feder, accomodated in an axled channel, formed in the sleeve, connected with the body of the chuck and tightened by a radially arranged tightening screw, as well as by a cylindrical feder, arranged between stoping faces of the axled bearing and the flange of the main location part.

The described mechanism for ensuring a definite tightening force and limited overtightening can be desighned to include a cylindrical belt and a gear ring with inner teeth, formed in the extended part of the sleeve, immovably connected with the body of the chuck, as the stoping faces of the teeth of the gear ring are radially arranged and their back parts are inclined and a catch is provided, arranged in a radial hole of a pulley, angulary orientated with a key and immovably connected with the main location part by a screw, when its fixing part is defined by the form and dimentions of one tooth from the gesr ring, but with the stoping face, arranged against the stoping faces of the teeth, as the catch is angulary orientated by means of a screw, axially arranged in the pulley and has a cylindrical feder, incorporated in its opening and the cylindrical feder is accomodated in the channel between the stoping faces of the axled bearing and the flange of the main location part.

The three-jaw chuck, object of the invention, represents an improved construction of a chuck, ensuring higher qualities and parameters of the three-jaw tightening chucks, which have a wide application.

The proposed construction defines a chuck, that contains and combines the positive qualities of the chucks from the known state of the art, simultaneously deleting their disadvantages. Therefore the chuck, object of the invention, can be defined as a construction, suitable for production, with the highest qualitative, technological and economical characteristics.

The construction, according to the invention, creates a three-jaw tightening chuck with high class of accuracy and qualitative characteristics by reduced manufacturing costs. The chuck is characterized by an increasesd force for tightening of the operating tool and the force from the applied rotational moment for tightening is transformed in tightening force, increased from the cylindrical threaded joint of the driving mechanism and from the both wedge-shaped mechanisms, as the contact of the operating teeth of the driving screw with the jaws to be tightened and the contact of the latter with the surfaces of the openings, where they are arranged. By using in the driving mechanism a cylindrical threaded joint with left-hand thread, a self-tightening of the operating tool is ensured during the work. In this way, by using of the three-jaw tightening chuck the reliability, safety and security are considerably increased.

As a substantial advantage can be indicated the use of simplified and effective driving mechanism. The specific shape of the driving screw defines synonymously its axial position, independent of the screw position in the threaded joint, in this way ensuring higher accuracy of contacting with the tightening jaws, as well as accuracy of tightening The tightening and releasing of the operating tool is fulfilled without using an additional key. The construction is maximally simplified, contains details with technological for production form, leading to considerable reduction of manufacturing costs, respectively the final price of the product

### BRIEF DESCRIPTION OF THE DRAWINGS

An example embodiment of the three-jaw tightening chuck, object of the invention, is shown with reference to the accompanying drawings, wherein:

FIG. 1—is a longitudinal section of a three-jaw tightening chuck

FIG. 2—view of the joining side of the main location part of a three-jaw tightening chuck with an outer cylindncal thread

FIG. 3—view of the joining side of the main location part of a three-jaw tightening chuck with an outer cone

FIG. 4—partial sectional view of a tightening jaw

FIG. 5—A-view of a two-staged channel of a tightening jaw

FIG. 6—B-view of a two-staged channel of a tightening jaw

FIG. 7—C-view of the tightening surface of a tightening jaw

FIG. 8—D-view of the tightening surface of a tightening jaw

FIG. 9—axonometric view of the cylindrical head of the driving screw

FIG. 10—E-view of the operating teeth of the driving screw

FIG. 11—F-view of the contact part of the operating teeth of the driving screw

FIG. 12—partial sectional view of the mechanism, ensuring a definite tightening force and limited overtightening

FIG. 13—cross-sectional view of the mechanism from FIG. 12

FIG. 14—partial sectional view of a variant embodiment of the mechanism from FIG. 12

FIG. 15—cross-sectional view of the mechanism from FIG. 14

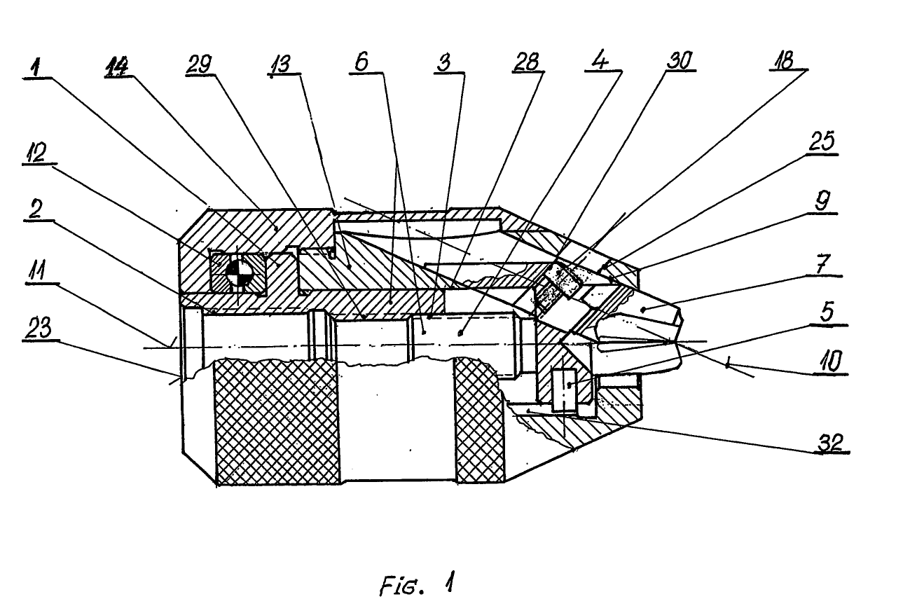

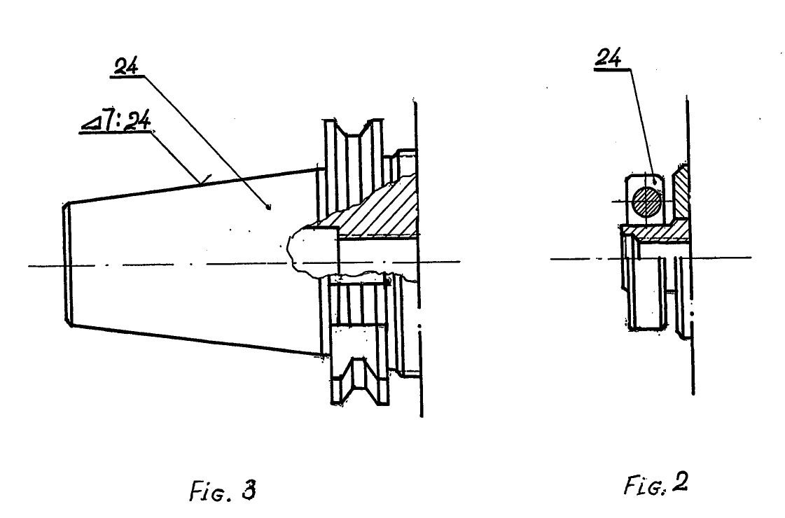

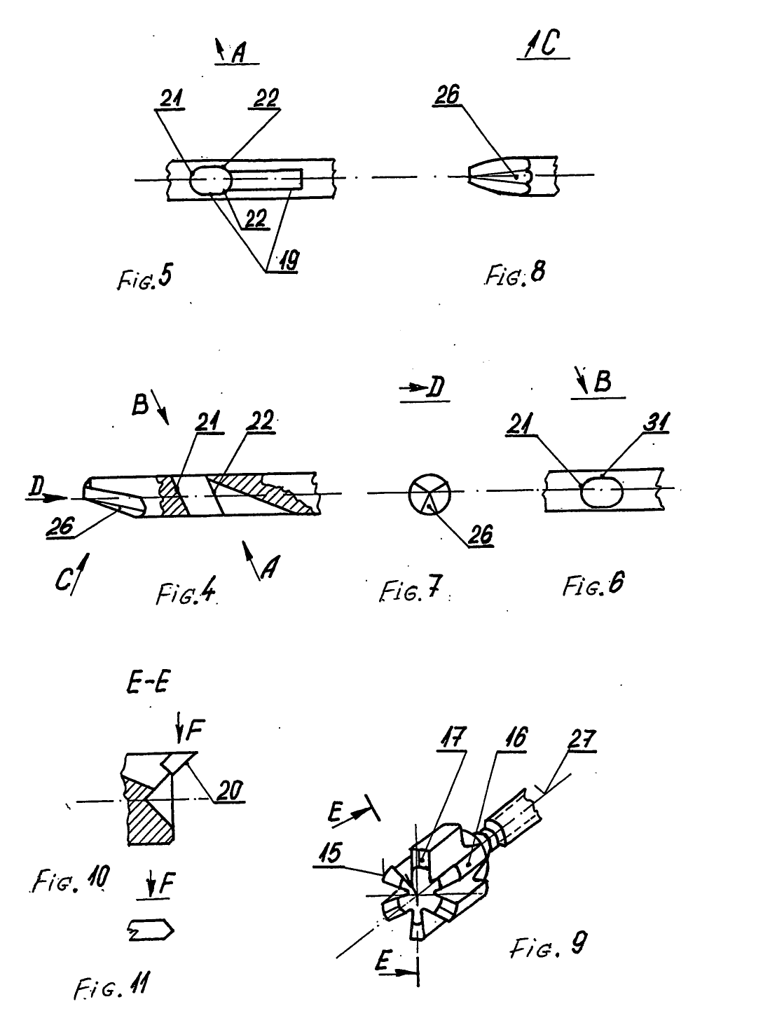

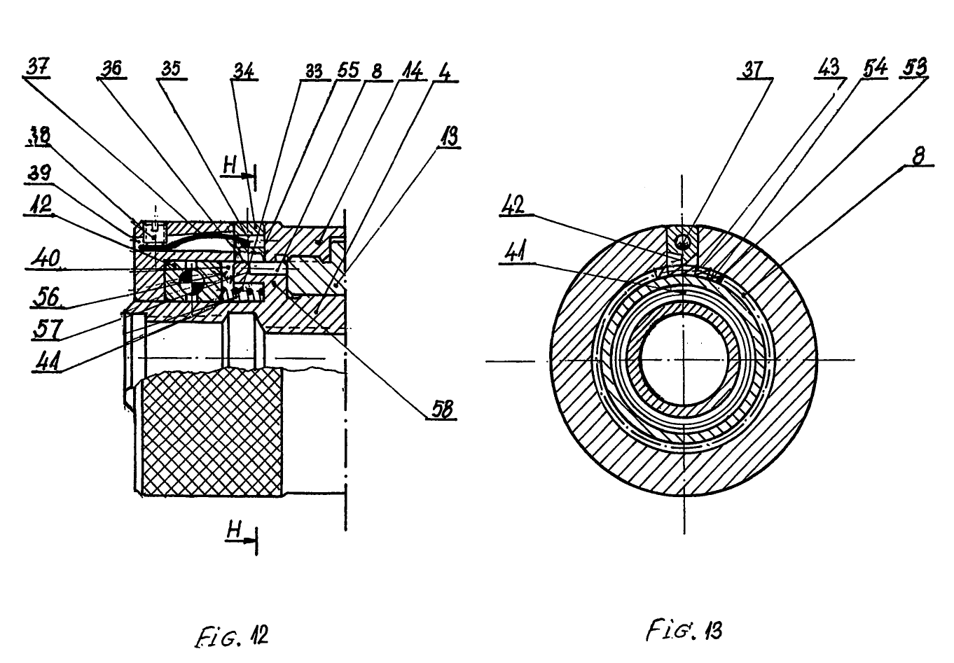

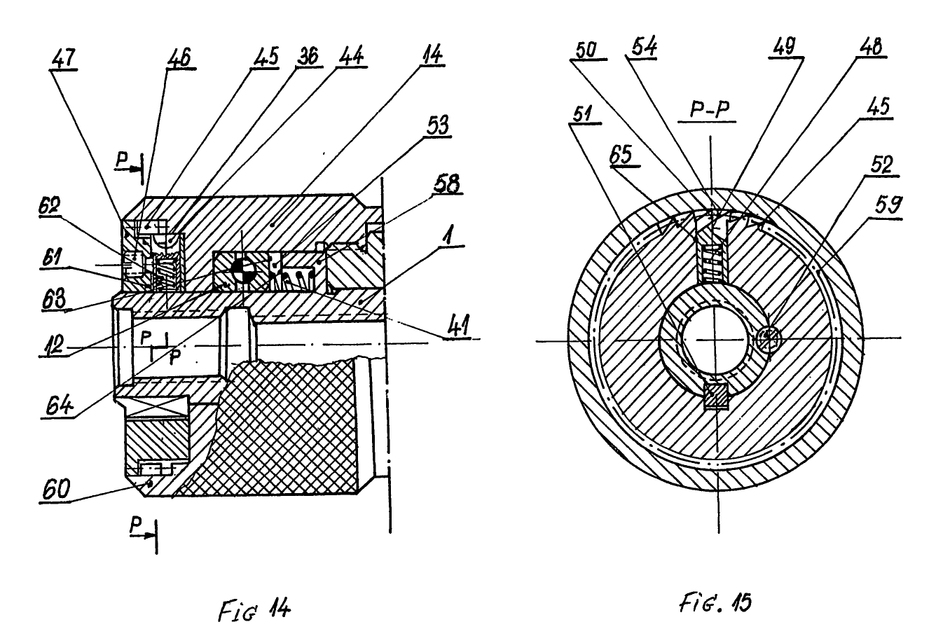

### DESCRIPTION OF THE PREFERED EMBODIMENT

Further in the description an example embodiment of the three-jaw tightening chuck is shown, object of the invention, as the detailed description of the elements and their constructive design do not limited the use of other equivalent elements, ensuring the same functional action.

The three-jaw tightening chuck comprises a main location part 1 with a main hole 2, formed in it, for coupling the part 1 to the driving machine. In the main location part 1 are centrally arranged a cylindrical threaded joint 3 and a driving screw 4, that together with a blocking pin S constitute a driving mechanism 6, by which gripping jaws 7 are moved for catching the operating tool, not shown in the figures. The gripping jaws are accomodated in a body 13 with three openings, the axis of which are inclined towards the axis 11 of the main location part 1, on which the body 13 and an immovably connected to him sleeve 14 are beard radially and axially with an axled bearing 12.

The cylindrical gripping jaws 7 are connected to the driving mechanism 6 by means of the driving screw 4, that in the part, contacted with the gripping jaws 7 is shaped as a cylindrical body 15 with three longitudinally guiding strips 16 and three operating teeth 17, to which medial releasing elements 18 are connected. The operating teeth 17 are movably united with the gripping jaws 7 by a channel with a bigger size of a two-staged channel 19, while the faces 20 of the operating teeth 17 are in contact with a semicylindrical surface 21 of the two-staged channel 19 and the medial releasing elements 18 are in contact with two semicylindrical strips 22 of the transitional zone of the two-staged channels 19.

The construction, object of the invention, permits an embodiment, where the main location part 1 has an extended length from the joining side 23 and the extended part is accomplished with outer cylindrical thread and connected to it a fixing nut 24.

A further variant embodiment of the chuck is possible, where the main location part 1 has an extention for coupling to the driving machine by means of a cone 7:24.

The gripping jaws 7 are released owing to the medial releasing elements 18, which are immovably connected with the driving screw 4 and are formed as screws with cylindrical head.

The medial releasing elements 18 can also be formed as conical pins with a threaded hole.

In the two-staged channels 19 of the gripping jaws 7 are formed surfaces 21 and 22, which are in contact with the operating teeth 17 of the driving screw 4 and are shaped as parts of cylindrical surfaces of a key channel or parts of a plane.

It is preferable the contact surfaces 21 and 22 to be formed inclined, at acute angle towards their surfaces 26 for tightening the operating tool, not shown in figures. It is admissible the contact surfaces 21 and 22 to be formed at right angle 90° towards the surfaces 26 for tightening the operating tool.

It is worth noting that the surfaces 26 of the gripping jaws 7 are formed identical as the surfaces, disclosed and described in Bulgarian patent No 63333 and the possibility of worsening the accuracy of rotation of the tightened tool, due to rotation also around the axis 10, is discount.

According to one variant embodiment of the gripping jaws 7, the surfaces 26 can be formed as parts of planes.

The contact surfaces 21,22 of the operating teeth 17 of the driving screw 4 are formed at such an angle towards its longitudinal axis 27, which to correspond to the inclination of the contact surfaces 21 and 22 of the two-staged channels 19, with which they are in contact.

In one prefered example embodiment of the three-jaw tightening chuck, according to the invention, one possibility is provided for building in in the above described construction a mechanism for ensuring a definite tightening force and limited overtightening. This mechanism includes a cylindrical belt 36 and a gear ring 8, formed on the outer cylindrical surface of a flange 58 of the main location part 1, as the stoping faces 43 of the teeth 53 of the gear ring 8 are radially arranged and their back part 54 is formed near the stoping face 43 of the following tooth 53 like an inclined plane, as well as a catch 34, arranged in a radial hole 55, formed in the sleeve 14, connected immovably with the body 13 of the chuck, when its fixing part is defined by the form and dimentions of one tooth from the gear ring 8, with which it is engaged, as his stoping face 42 is arranged against the stoping faces 43 of the teeth and the catch 34 is connected by means of a transverse opening 35 with a feder 37, accomodated in an axled channel 39, formed in the sleeve 14, connected with the body 13 of the chuck and tightened by a radially arranged tightening screw 38, as well as by a cylindrical feder 41, arranged between stoping faces 56 and 57 of the axled bearing 12 and the flange of the main location part 1.

The three-jaw tightening chuck, according to the invention, can be constructed by using a variant embodiment of the mechanism for ensuring a definite tightening force and limited overtightening. In this case the mechanism includes a cylindrical belt 36 and a gear ring 59 with inner teeth, formed in the extended part 60 of the sleeve 14, immovably connected with the body 13 of the chuck, as the stoping faces 50 of the teeth 45 of the gear ring 59 are radially arranged and their back parts 54 are inclined and a catch 44 is provided, arranged in a radial hole 61 of a pulley 47, angulary orientated with a key 51 and immovably connected with the main location part 1 by a screw 52, when its fixing part is defined by the form and dimentions of one tooth from the gesr ring 59, but with the stoping face 49, arranged against the stoping faces of the teeth 45, as the catch is angulary orientated by means of a screw 46, axially arranged in the pulley 47 and has a cylindrical feder 48, incorporated in its opening 65 and the cylindrical feder 41 is accomodated in the channel 53 between the stoping faces 63 and 64 of the axled bearing 12 and the flange 58 of the main location part 1.

### APPLICATION OF THE INVENTION

The three-jaw tightening chuck, according to the invention, is used as follows: the chuck is secured to the spindle of the operating machine through the main hole 2, formed in the main location part 1. The tightened tool is engaged in the opening, formed from the surfaces 26 of the gripping jaws 7, after that by rotation of the sleeve 14, connected to the body 13, in which the gripping jaws 7 are arranged, the driving screw is unscrewed or screwed; being led on the opening 28 by means of its three transverse guiding strips 16. In this way the tightening or untightening of the operating tool is realized.

The construction of the chuck allows light tightening and untightening of the operating tool, as the sleeve 14 together with the body 13 are immovable and the main location part 1 is set in rotary motion, by which the driving screw is axially driven.

It is possible the operating tool to be tighten and untighten through simultaneously rotation in opposite direction of the main location part 1 and the body 13 with the sleeve 14.

The mechanism for ensuring a definite tightening force, as well as limiting the overtightening is used according to his prinziple of action and namely—ensuring an axial movement between the main location part and the sleeve, connected immovably with the body of the chuck and the remain elements, in which the catch and the gear ring are arranged.

The necessary axial movement is established from the arising repulsive force by tightening in threaded joint 3 between the main location part 1 and the driving screw 4, connected to him. For this aim a distance 40 is provided between the stoping faces 56 and 57 of the axled bearing 12 and the flange 58 of the main location part 1 under the constant action of the cylindrical spiral feder 41, arranged between them.

By free mutual rotation between the main location part 1 and the sleeve 14, the catch 34 is in contact with the cylindrical belt 36, arranged near the gear ring 8, the catch being in passive position. In position, when the gripping jaws 7 envelop the operating tool on purpose of his tightening, an axial repulsive force arises in the threaded joint 3 between the main location part 1 and the driving screw 4, when the latter moves together with the gripping jaws 7, the body 13 and the sleeve 14 in relation to the main location part 1, until a contact is established between the stoping faces 56 and 57 of the axled bearing 12 and its flange 58. The catch 34 goes out from its neutral position and under the action of the tightening feder 37 takes up a new position, in some space between the teeth of the gear ring 8. Then through additional rotation a tightening force and limiting overtightening are ensured untill an contact is established between the stoping face 43 of the catch 34 and the stoping ace 43 of the respective tooth of the gear ring 8.

The untightening is realized through the rotation in back direction, as the catch 34 is in contact with the inclined surface of the back part 54 of the tooth from the gear ring 8, orientated in the direction of rotation. The rotation for untightening is accompanied with an axial movement of the driving screw 4 and the connected with him gripping jaws 7, the body 13 and the sleeve 14, under the action of the cylindrical feder 41, as at the end of the rotational movement the catch 34 takes up the initial neutral position on the cylindrical belt 36, arranged near the gear ring 8.

The action of the mechanism for ensuring definite tightening force and limiting the overtightening, constructed with inner teeth in its principle part does not distinguished from the described action of the mechanism for ensuring definite tightening force and limiting the overtightening, with outer teeth.

1-7. (canceled)

8. A three-jaw tightening chuck, comprising a body with three openings, the axes of which are inclined towards the axis of the body, the openings being arranged at 120° one to the other and in which cylindrical gripping jaws are accommodated, connected with a driving mechanism and including a mechanism with a main hole in the body for attachment to the driving machine, wherein the driving mechanism is located coaxially in the body and is formed with a cylindrical threaded joint and a driving screw connected with the gripping jaws as a cylindrical body with three longitudinal guiding strips, orientated at 60° towards three operating teeth, which angled orientation coincides with those of the three inclined openings in the body, to which medial releasing elements are also connected, with the operating teeth movably united with the gripping jaws by a channel with bigger size of a two-staged channel, formed in each gripping jaw, with faces of the operating teeth beveled and in contact with a semicylindrical surface of the two-staged channel and the medial releasing elements in contact with two transverse semicylindrical strips of the transitional zone of the two-staged channels, with the body immovably connected with a sleeve and beared radially and axially with an axled bearing on the main location part and the driving screw connected with the gripping jaws and fixed to the body by means of a blocking pin and a channel.

9. The three-jaw tightening chuck according to claim 8, wherein the medial releasing elements are formed as screws with cylindrical heads or as conical pins with threaded holes and are connected by means of a dismountable joint with the operating teeth of the driving screw.

10. The three-jaw tightening chuck according to claim 8, wherein the contact surfaces of the two-staged channels, formed in the gripping jaws, are shaped as parts of cylindrical surfaces of a key channel or parts of planes.

11. The three-jaw tightening chuck according to claim 8, wherein the contact surfaces of the two-staged channels, formed in the gripping jaws, are shaped inclined at acute angles or at right angles towards the surfaces for tightening the operating tool.

12. The three-jaw tightening chuck according to claim 8, wherein the surfaces for tightening the operating tool of the gripping jaws are formed as parts of an inner cylindrical surface or are formed as parts of planes.

13. The three-jaw tightening chuck according to claim 8, wherein the contact surfaces of the operating teeth of the driving screw are formed at an angle towards its longitudinal axis, which corresponds to the angle of inclination of the contact surfaces of the two-staged channels of the gripping jaws, with which they are in contact.

14. The three-jaw tightening chuck according to claim 8, wherein the joining side of the main location part is formed as an extension with a thread and connected to a nut, fixed with a screw, or as extension in the form of a standard cone.
